(19) United States
(12) Patent Application Publication
(10) Pub. No.: US 2017/0358400 A1
(43) Pub. Date: Dec. 14, 2017

(54) GRAPHENE PAPER AND A PROCESS FOR MAKING GRAPHENE PAPER AND A GRAPHENE ELECTRODE

(71) Applicant: University Of Cincinnati, Cincinnati, OH (US)

(72) Inventors: Noe Alvarez, Cincinnati, OH (US); Derek DeArmond, Cincinnati, OH (US); Rachit Malik, Cincinnati, OH (US); Vesselin N. Shanov, Cincinnati, OH (US); Lu Zhang, Cincinnati, OH (US)

(21) Appl. No.: 15/619,388

(22) Filed: Jun. 9, 2017

Related U.S. Application Data
(60) Provisional application No. 62/347,862, filed on Jun. 9, 2016.

(51) Int. Cl. H01G 11/42; B01J 37/00; H01G 11/34; C01B 32/186; B01J 37/08; C25D 9/04; B01J 23/755; B01J 35/02; C01B 32/194; B82Y 30/00; H01M 4/66; B82Y 40/00

(52) U.S. Cl. CPC H01G 11/42; B01J 35/026; B01J 37/0063; H01G 11/34; C01B 32/186; C01B 32/194; B01J 37/08; C25D 9/04; B01J 23/755; H01M 4/663; Y10S 977/843; Y10S 977/948; B82Y 40/00; C01P 2006/40; B82Y 30/00; Y10S 977/734

(57) ABSTRACT

Described are processes for making graphene pellet (GP) with a three-dimensional structure. The process includes forming a nickel pellet from nickel powder to function as a catalyst for graphene growth, exposing the nickel pellet to a hydrocarbon under conditions sufficient to grow graphene, and etching nickel from graphene with an acid resulting in a graphene pellet. Also described is a process for making a graphene paper from the graphene pellet comprising applying a compression force to the graphene pellet sufficient to compress the pellet. Also described is a method for forming a graphene pellet composite useful as an electrode.

### CROSS-REFERENCE TO RELATED APPLICATIONS

This application claims the benefit of and priority to prior filed pending Provisional Application Ser. No. 62/347,862, filed Jun. 9, 2016, which is expressly incorporated herein by reference in its entirety.

### FIELD

The present invention relates generally to graphene materials and more particularly to graphene materials with a specific three-dimensional structure and process of making and using the same.

### BACKGROUND

Syntheses of multifunctional structures, both in two-dimensional and three-dimensional space, are essential for the application of graphene. A variety of graphene-based materials have been reported in recent years, but combining the excellent mechanical and electrical properties in bulk graphene has not been easily achieved. Graphene pellet has been synthesized by chemical vapor deposition, using inexpensive nickel powder as a catalyst. Graphene-based paper materials with high electrical conductivity have been reported in the past. Such materials also reveal significant electromagnetic interference (IME) shielding effectiveness (SE). With a remarkable combination of good mechanical and electrical properties of these materials, they appear to be promising in applications such as supercapacitors, antennas, EMI shields, and sensors.

Graphene is a single-layer, two-dimensional lattice consisting of a hexagonal array of sp²-bonded carbon atoms. First reported in 2004, graphene has attracted attention from diverse fields, due to its outstanding mechanical, quantum, and electrical properties. Graphene was first prepared by micro-mechanical exfoliation of graphite crystals. Subsequently, other methods to synthesize graphene were developed, including epitaxial growth on SiC, chemical reduction from graphene oxide and chemical vapor deposition growth on metal substrates such as ruthenium, nickel and copper. Graphene prepared by these and other methods is often used to produce more conventional macromaterials, such as papers.

Among the many graphene-based materials, paper-like graphene stands out for its potential in applications such as in fuel cells, structural composites, and electromagnetic interference (EMI) shielding materials. This potential is due to the low density, excellent flexibility, and electrical properties of graphene materials. Graphene paper is mostly prepared by using graphene oxide as a template for synthesis and processing. However, the poor conductivity of graphene oxide—resulting from the introduction of oxygen and surface defects during preparation—limits its applications. chemical vapor deposition made graphene has an overall high quality and by using this method, high quality graphene paper with good electrical conductivity has been achieved by filtration of graphene foams, but the expensive template—nickel foam—prevent this technique from being used on industrial scales. Inexpensive nickel particles were reported recently as a catalyst to synthesize bulk graphene by chemical vapor deposition with limited success to achieve the organized macrostructure of graphene. Further complicating the matter is the fragility of current graphene macromaterials. Polymer reinforcement is often required to improve handle-ability, and to transfer the material for processing; however, polymers and polymer residues can negatively impact the electrical properties of graphene materials.

The fast development of renewable and sustainable energy techniques such as solar cells and wind turbines requires efficient energy storage systems to offset the intermittency problem caused by the sustainable energy resources. Among various energy storage systems, electrochemical capacitors (ECs) outstand as promising devices providing solutions for the intermittency problem. Although ECs exhibit several appealing characteristics including: fast charge-discharge rate, long cyclic life, high power density and high reliability, the relatively low energy density of ECs when compared to batteries and fuel cells often limits their wide applications. To compensate this deficiency of ECs, pseudocapacitive materials (such as transition metal oxides and conducting polymers) have been studied extensively due to their ability to offer high energy density. However, poor electrical conductivity and mechanical properties of many pseudocapacitive materials, such as MnO₂, hinder their applications as ECs, especially when high power density is required.

Carbon materials have been widely utilized in design of pseudocapacitor electrode to work as scaffolds to hold pseudocapacitive materials, current collectors and as agents for control of heat transfer, porosity, surface-area and capacitance. Traditional carbon materials including active carbon, carbon black and carbon aerogel, have high specific surface area (SSA) and tunable porosity, but their relatively disordered structure results in low electrical conductivity or poor mechanical properties, thus hindering their application as a pseudocapacitor electrode.

Graphene is a promising carbon electrode material for pseudocapacitor due to its high SSA, excellent electrical properties and good mechanical properties. However, there are difficulties to transfer these desirable properties into bulk structures. One major problem in preparation of graphene electrode materials is the restacking of graphene sheets during processing, which decreases the SSA of the overall electrode structure. Deformations of graphene flakes such as curved, folded and crumpled graphene have been successfully used to prevent the restacking of graphene flakes. These approaches result in an enhanced specific capacitance of ECs, however, the mechanical or electrical properties of overall electrode structure are negatively affected due to the deformation. The conformation of graphene flakes into three-dimensional (3D) structures is a promising approach to avoid the restacking of graphene. Usually, graphene flakes in the 3D structures are physically bonded together by van der Waals force resulting in a low efficient electron transfer between different graphene flakes and in overall poor mechanical properties. Moreover, these 3D graphene structures suffer from reduced electrical conductivity because of the low quality and/or high contact resistance of the chemically derived graphene sheets.

Recently, seamless 3D graphene structures have been reported using synthesis through chemical vapor deposition, in which more efficient electron transfer paths were created due to the monolithic graphene structure. However, the lack of pore size control of this 3D graphene structure resulted in an overall low electrical conductivity and poor mechanical properties due to the macro-pore size dominated structure. The application of this 3D graphene structure is further limited by its costly catalyst substrate such as nickel foam. Therefore, a low cost, seamless 3D graphene with improved properties: such as tunable pore size, excellent electrical properties and good mechanical performances is required for high performance pseudocapacitor electrode design.

### SUMMARY

Described herein are embodiments of a freestanding graphene paper which includes three dimensional (3D) graphene as well as embodiments of processes for making freestanding graphene paper. In an embodiment, the initial 3D graphene is synthesized by chemical vapor deposition using pelletized nickel powder as a catalyst. After this initial synthesis step, the nickel template is etched out by immersion in hydrochloric acid (HCl acid), leaving a freestanding 3D graphene pellet. After drying, the obtained graphene retained a three-dimensional structure, albeit with reduced dimensions compared to the initial nickel pellet. In embodiments of the invention, the graphene pellet may be further processed by pressing it to form a graphene paper with a 3D structure. Embodiments of a 3D graphene paper made according to the processes described herein may be useful in a wide range of applications including, but not limited to EMI shielding, sensors, batteries and supercapacitors, which utilize the special properties of the 3D graphene paper.

Also described herein are coated graphene pellets, electrodes made from coated graphene pellets, electrochemical capacitors (ECs) made from the electrodes, and processes for making the same.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a schematic representation of a process for producing a graphene paper in accordance with aspects of the invention.

FIG. 2 is a photograph of a graphene paper in accordance with aspects of the invention.

FIG. 3. is a graph illustrating a stress strain curve for a graphene paper.

FIG. 4A is a photomicrograph of a graphene paper in accordance with aspects of the invention.

FIG. 4B is another photomicrograph of a graphene paper in accordance with aspects of the invention.

FIG. 4C is another photomicrograph of a graphene paper in accordance with aspects of the invention.

FIG. 5A is a series of graphics and photomicrographs illustrating the process for producing a graphene pellet in accordance with aspects of the invention.

FIG. 5B is a pair of photomicrographs comparing graphene foam, left panel, with graphene paper produced in accordance with aspects of the invention.

FIG. 5C is a graph showing the Raman shift of graphene pellet in accordance with aspects of the invention.

FIG. 5D is a photograph illustrating the mechanical properties of a graphene pellet in accordance with aspects of the invention.

FIG. 6 is a graph showing the effect of carbohydrate flow rate during chemical vapor deposition on the density and areal density of a graphene paper produced in accordance with aspects of the invention.

FIG. 7 is a graph showing the effect of carbohydrate flow rate during chemical vapor deposition on electrical conductivity of a graphene paper produced in accordance with aspects of the invention.

FIG. 8 is a graph demonstrating the electrical conductivity of exemplary 1.9 vol. % CH₄ graphene paper as a function of the graphene paper thickness.

FIG. 9 is a tracing of EMI SE from exemplary graphene paper fabricated with (i) 0.9 vol % CH₄, (ii) 1.1 vol % CH₄, (iii) 1.9 vol % CH₄, and (iv) two overlapping specimens with 1.9 vol % CH₄.

FIG. 10 is a graph depicting specific SE of graphene paper manufactured with different CH₄ concentrations in accordance with embodiments of the invention.

FIG. 11 is a graph of the effect of the methane concentration during the chemical vapor deposition process on electrical conductivity.

FIG. 12 is a graph showing the effect of bend radius of a graphene paper on electrical resistance.

FIG. 13 is a graph showing the cyclic bend and release test of graphene pellets over 5,000 cycles.

FIG. 14A is a photomicrograph of a pristine graphene pellet.

FIG. 14B is a photomicrograph of a deposited graphene pellet/MnO₂.

FIG. 14C is another photomicrograph of a deposited graphene pellet/MnO₂ composite.

FIG. 14D is another photomicrograph of a deposited graphene pellet/MnO₂ composite.

FIG. 15 is a graph showing X-ray photoelectron spectroscopy data on graphene pellet/MnO2 composite.

FIG. 17 is a graph of cyclic voltammetry (CV) curves of graphene—MnO₂ composites.

FIG. 18 is a graph showing the increase of both specific and volumetric capacitance of graphene pellet/MnO₂ composite electrodes.

FIG. 19 is a graph displaying the charge-discharge curves of graphene pellet/MnO₂ composite.

FIG. 20 is a graph showing the effect of repeated cycles of charge-discharge capacitance retention.

FIG. 21 is a graph of alternating current impedance measurements.

FIG. 22 is a graph of cyclic voltammetry (CV) curves.

FIG. 23 is a graph showing the increase of both specific and volumetric capacitance.

FIG. 24 is a graph displaying the charge-discharge curves.

FIG. 25 is a Nyquist plot of a graphene pellet/MnO₂ composite.

FIG. 26 is a graph showing the CV curves of the pristine graphene pellet in 1 M H₂SO₄ and 30% acetic acid electrolyte with 50 mM hydroquinone (HQ) and 50 mM benzo-quinone (BQ) as redox additives.

FIG. 27 is a charge-discharge curve for a graphene pellet/MnO₂ composite.

FIG. 28 is a graph showing the effect of repeated cycles of charge-discharge on capacitance retention.

FIG. 29 is a graph showing the effect of repeated cycles of charge-discharge on R_{ct}.

FIG. 30 is a schematic representation of a electrochemical capacitor produced in accordance with aspects of the invention.

FIG. 31 is a graph showing the capacitance behavior of an assymetric EC produced in accordance with embodiment of the invention.

FIG. 32 is a charge-discharge curve for an assymetric EC produced in accordance with embodiment of the invention.

FIG. 33 is a Nyquist plot for an assymetric EC produced in accordance with embodiment of the invention.

FIG. 34 is a Ragone plot for an assymetric EC produced in accordance with embodiment of the invention.

FIG. 35 is a graph showing capacitance retention for an assymetric EC produced in accordance with embodiment of the invention.

FIG. 36 is a photograph of a electrochemical capacitor powering an LED.

### DETAILED DESCRIPTION

Aspects of the invention are directed to freestanding graphene paper. Another aspect of the invention is directed to processes of preparing a freestanding graphene paper. Another aspect is directed to a graphene/pseudocapacitive material composites and methods of making the same. Another aspect is directed to electrodes and electrical devices made with such graphene/pseudocapacitive material composites.

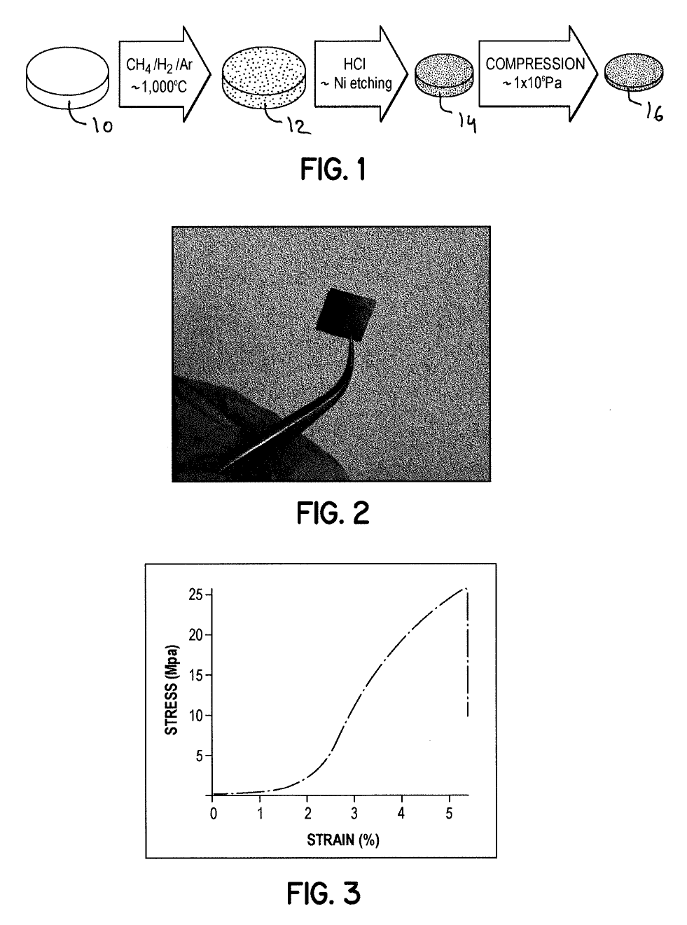

With reference to FIG. 1, in an embodiment of the method, a nickel powder is formed into a pellet 10. In an embodiment, the nickel powder may have an average particle size in a range from 1 μm to 4 μm, and in another embodiment, the average particle size is in a range from 2 μm to 3 μm. In embodiments, the nickel particles may have a specific surface area in a range from 0.6 m²/g to 0.8 m²/g, and in another embodiment, the specific surface area is a range from 0.65 m²/g to 0.7 m²/g, and in another embodiment, the specific surface are is 0.68 m²/g. An exemplary nickel powder is available from Alfa Aesar.

In embodiments of the method, the nickel powder is formed into a pellet 10 using a compression device. An exemplary compression device is available from Carver (973214A). As illustrated in Table 1 from Example 1, the thickness and density of the nickel pellet 10 may be adjusted based on the force of the compression.

In an embodiment, the force applied to the nickel pellet 10 is in a range from 5.5×10⁴ Pa to 1.1×10⁶ Pa and in another embodiment, the applied force is in a range from 1.1×10⁵ Pa to 1.1×10⁶ Pa, and in another embodiment, the applied force is in a range from 2.2×10⁵ Pa to 1.1×10⁶ Pa, and in another embodiment, the applied force is in a range from 3.5×10⁵ Pa to 1.1×10⁶ Pa, and in another embodiment, the applied force is about 1.1×10⁶ Pa and in another embodiment, the applied force is about 1×10⁶ Pa. In an embodiment, the applied force may be up to about 1.1×10⁶ Pa.

In embodiments of the invention, the nickel pellet 10 may range in thickness from 110 μm to 25 μm, and in another embodiment, the thickness may range from 60 μm to 30 μm, and in another embodiment, the thickness may range from 50 μm to 30 μm, and in another embodiment, the thickness may range from 45 μm to 30 μm and in another embodiment, the thickness in a range from 30 μm to 35 μm.

In embodiments of the invention, the nickel pellet 10 has a density in a range from 0.4 g/cm³ to 1.5 g/cm³, and in another embodiment, the density is in a range from 0.8 g/cm³ to 1.5 g/cm³, and in another embodiment, the density is in a range from 0.9 g/cm³ to 1.5 g/cm³, and in another embodiment, the density is in a range from 1 g/cm³ to 1.5 g/cm³.

The size of the nickel pellet 10 is typically limited by the size of the available compression device. In an exemplary embodiment, the nickel pellet 10 has a diameter in a range from 5 cm to 10 cm, in another exemplary embodiment, the nickel pellet 10 has a diameter in a range from 5.5 cm to 7 cm, and in another embodiment, the nickel pellet 10 has a diameter in a range from 6 cm to 6.5 cm.

In embodiments of the invention, the nickel pellet 10 is sintered prior to growing graphene on the nickel in the pellet 10. In exemplary embodiments, the nickel pellet 10 is heated to a temperature up to 1,000° C. under argon gas. The Ar may have a flow rate of 1,000 sccm. The nickel pellet 10 may be heated in a furnace, such as a tube furnace.

In embodiments of the method, hydrogen is then introduced to the heated pellet to reduce any metal catalyst oxide that might be present in the nickel pellet 10. In exemplary embodiments, the pellet is exposed to H₂ having a flow rate of 325 sccm for a duration of 5 minutes. The flow rate and the duration of hydrogen exposure may be adjusted as necessary to remove metal catalyst oxides. If the pellet is devoid of oxides, this step may not be necessary.

Graphene is then grown on the nickel pellet 10 via chemical vapor deposition. The heated nickel pellet is exposed to a hydrocarbon gas under conditions sufficient for graphene growth on the nickel particles in the pellet. In an embodiment, the temperature of the nickel pellet 10 during the hydrocarbon exposure step is 1,000° C. In an embodiment, the hydrocarbon is CH₄. The hydrocarbon may have a flow rate from 1 sccm to 30 sccm, and in alternative embodiments, the flow rate is in a range from 12 sccm to 28 sccm, and in alternative embodiments, the flow rate is in a range from 15 sccm to 27 sccm, and in alternative embodiments, the flow rate is in a range from 15 sccm to 26 sccm, and in alternative embodiments, the flow rate is in a range from 18 sccm to 25 sccm. The hydrocarbon flow rate may result in hydrocarbon concentrations that ranges from 0.9 vol. % to 2.2 vol. %, and in an alternative embodiment, the hydrocarbon concentration is in range from 0.9 vol. % to 2.1 vol. %, and in an alternative embodiment, the hydrocarbon concentration is in range from 0.9 vol. % to 2 vol. %, and in an alternative embodiment, the hydrocarbon concentration is in range from 1.1 vol. % to 2 vol. %, and in an alternative embodiment, the hydrocarbon concentration is in range from 1.3 vol. % to 2 vol. %, and in an alternative embodiment, the hydrocarbon concentration is in range from 1.5 vol. % to 2 vol. %, and in an alternative embodiment, the hydrocarbon concentration is in range from 1.8 vol. % to 2 vol. %, and in an alternative embodiment, the hydrocarbon concentration does not exceed 2 vol. %.

The heated nickel pellet 10 may exposed to hydrocarbon for a duration sufficient to result in graphene growth on the zinc particles in the pellet. In an embodiment, the duration is in a range from 10 seconds to 5 minutes, and in an alternative embodiment, the duration is in a range from 30 seconds to 2 minutes, and in another embodiment, the duration is in range from 45 seconds to 90 seconds, and in an another embodiment, the duration is in a range from 55 seconds to 65 seconds, and in another embodiment, the duration is 1 minute.

After the graphene growth step is complete, the graphene coated pellet is cooled to room temperature. In an embodiment, the graphene coated pellet 12 is cooled at a rate of from 90° C./min to 110° C./min, in another embodiment, the graphene coated pellet 12 is cooled at a rate from 95° C./min to 105° C./min, and in another embodiment, the graphene coated pellet 12 is cooled at a rate of 100° C./min. In embodiments of the method, the graphene coated pellet 12 is cooled under Ar and H₂ gas. In an exemplary embodiment, the Ar flow rate may be 1,000 sccm and the H2 flow rate may be 325 sccm.

After cooling, the nickel is etched from the pellet 12 to result in a 3D graphene pellet 14. In an embodiment, nickel is etched from the graphene coated pellet 12 with an acid, such as hydrochloric acid (3M). The graphene coated pellet 12 may be etched for a duration and under conditions sufficient to remove substantially all the nickel from the graphene. In an embodiment, the graphene coated pellet is exposed to 3M hydrochloric acid at a temperature of 80 C for 10 hours. It will be appreciated that the duration and conditions for the etching step may be adjusted as necessary to result in sufficient removal of nickel. The resulting graphene pellet 14 is then wash, such as with deionized water to remove residual acid. After washing, the graphene pellet 14 is dried. In an embodiment, the graphene pellet 14 may be dried at room temperature, and in another embodiment, the graphene pellet 14 is dried at an elevated temperature.

The graphene pellet 14 has a three-dimensional structure, exhibits good mechanical strength, and does not require polymer reinforcement. As demonstrated in the examples, the polymer free graphene pellet 14 also good electricity conducting properties. The graphene pellet 14 may be used in this state or it may be further processed. In an embodiment, the graphene pellet 14 is processed into graphene paper 16. In another embodiment, the graphene pellet 14 is coated and processed into an electrode.

In an embodiment, the graphene pellet 14 may be processed into graphene paper 16 by compressing the graphene pellet 14. The thickness of the graphene paper 16 is determined in part by the compressive load. For example, the graphene pellet 14 may be compressed in a compression device, such as the device used to form the nickel pellet 10. The graphene pellet 14 may be compressed through the application of a force that results in the desired amount of compression. In an embodiment, the applied force ranges from 0.1 MPa to 1.1 Mpa.

The resulting graphene paper 14 (FIG. 2) has outstanding physical and electrical properties. The graphene paper 14 is characterized as being flexible and capable of being folded to at least 180° while still be able to return to its original shape. The graphene paper also show an excellent mechanical strength, especially when compared to other graphene materials made with chemical vapor deposition techniques. In an embodiment, graphene paper made as describe above with 1.9 vol. % CH₄ has a breaking stress at around 25 MPa (FIG. 3). This stress value is higher than previously developed graphene foam reinforced with a PMMA coating. The obtained mechanical strength accounts for the robustness of graphene paper processed from graphene pellet. This robustness allows the graphene paper to be manufactured without the use of any polymer support.

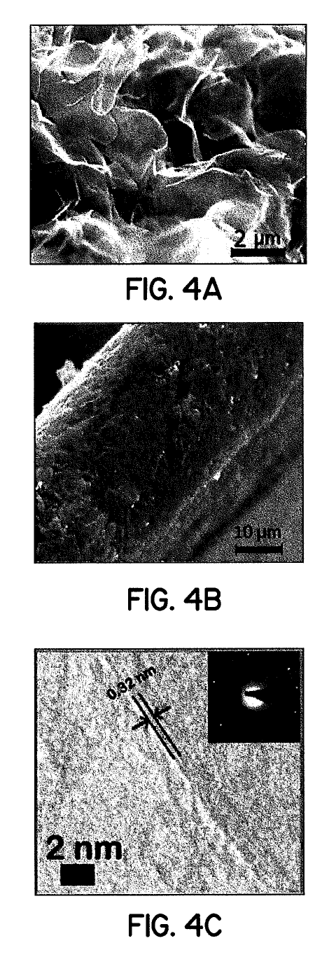

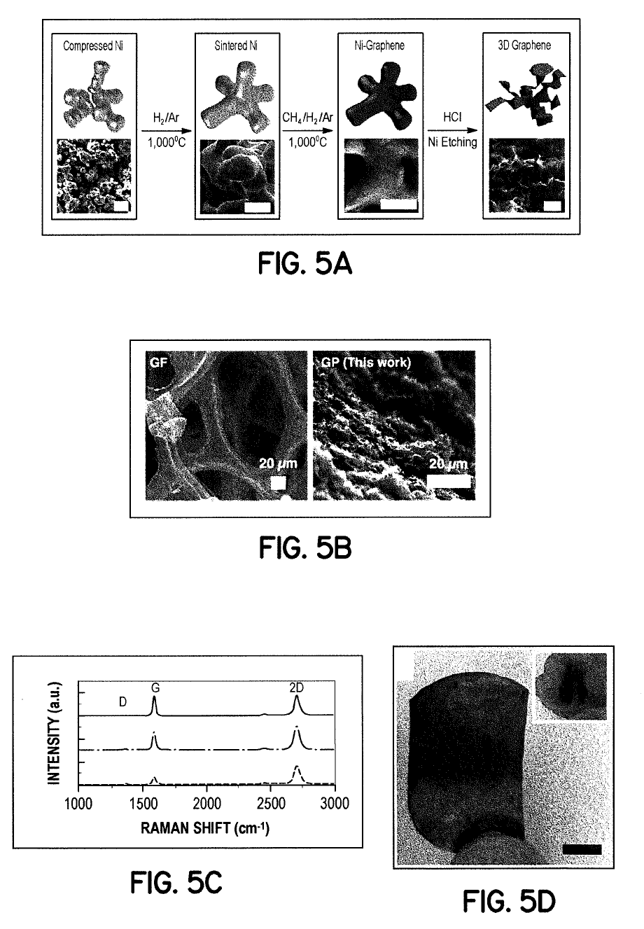

The morphology of graphene paper as determined by scanning electron microscopy (SEM) (FIGS. 4A and 4B) includes wrinkles and ripples of graphene flakes. This morphology may be caused by the difference between the thermal expansion coefficients of nickel and graphene. Gaps among graphene flakes are created when the nickel powered is are extracted from the graphene coated nickel pellet 12 leaving multiple graphene flakes in random 3D positions (FIG. 5A). FIG. 5B compares the physical structure of graphite foam with the structure of graphite paper prepared according to embodiments of the present invention. Due to the good mechanical strength, the cross-section thickness and morphology of the graphene paper can also be revealed by SEM (FIG. 4C). This image shows the graphene paper is composed of highly compacted flakes and the thickness of the tested graphene paper is ˜35 μm. The high-magnification transmission electron microscopy (TEM) image (FIG. 4C) displays a four-layer structure of graphene flake with a distance of 0.32 nm between each layer. The inserted diffraction pattern in FIG. 4C indicates the graphene flakes within the paper reveal a multilayer structure, which is in agreement with the TEM image. Unlike graphite, which has a broad 2D peak at 2730 cm⁻¹ in its Raman spectrum, the present graphene paper has a sharp 2D peak at 2707 cm⁻¹ indicating fewer layers of graphene (FIG. 5C). The suppressed D peak in the Raman spectrum of the graphene paper suggests high graphene quality.

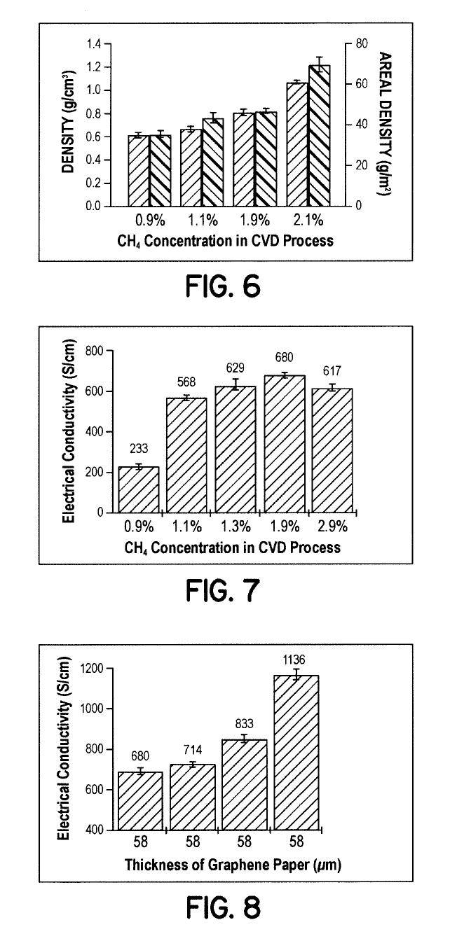

The obtained graphene paper has a low density. Embodiments of the graphene paper have a density in the range of 0.6 g·cm⁻³ to about 1.1 g·cm⁻³. Within this range, the density may be controlled either chemically, by adjusting the methane concentration during synthesis (FIG. 6), or physically, by varying the force used to possess the graphene pellet into graphene paper (Table 1). When chemically controlling the graphene density, a higher carbon precursor concentration results in a denser and better-interconnected graphene structure. In addition, the carbon adsorption capacity of the catalyst during the chemical vapor deposition process may also play a role. As bulk density of graphene paper varied significantly when changing the pressing load, areal density was used to investigate the independent contribution of CH₄ to the density of graphene structure (FIG. 4A). With the same compression load, higher areal density graphene paper can be obtained by increasing the CH₄ during chemical vapor deposition process. When physically controlling the graphene density, higher mechanical compression leaves smaller voids between the graphene flakes, thus increasing the density dramatically (Table 1). Further, the increased density improves the electron transfer in the whole graphene structure by reducing interflake resistance.

TABLE 1
Impact of the compression pressure on the thickness
and density of graphene paper prepared with 1.9 vol %
CH₄ in the chemical vapor deposition reactor

| Pressure (Pa) | Thickness (μm) | Density (g · cm⁻³) |
|---|---|---|
| NA* | 324 | 0.14 |
| 5.5 × 10⁴ | 103 | 0.45 |
| 1.1 × 10⁵ | 58 | 0.81 |
| 2.2 × 10⁵ | 50 | 0.93 |
| 3.7 × 10⁵ | 44 | 1.06 |
| 1.1 × 10⁶** | 32 | 1.46 |

*The original thickness of the graphene pellet prepared from a 3 mm thick nickel pellet.
**Further compression did not yield smaller thickness of the graphene paper due to the inner resistance of the graphene flakes within the structure.

Varying the density, either by adjusting it chemically or physically, significantly affects the electrical conductivity of the graphene paper. For example, graphene paper produced with 0.9 vol. % CH₄ concentration has a conductivity of about 233 S cm⁻¹ and increases up to about 680 S·cm⁻¹ when increasing CH₄ to 1.9 vol. % (FIG. 7). However, once CH₄ concentration exceeds a certain threshold, further increasing the concentration will lead to amorphous carbon accumulation, which decreases the electrical conductivity of the graphene paper. In an embodiment, this threshold is around 2 vol. % of CH₄ at ambient pressure because about 2.1 vol % CH₄ decreased the conductivity value of the resulting graphene paper down to about 617 S·cm⁻¹. Additionally, carbon deposits heavily on the chemical vapor deposition furnace tube if the methane concentration exceeds this threshold value.

The thickness of graphene paper is determined in part by the compressive load. It was found that a load of about 0.1 MPa produces a 58 μm thick paper, while a load of about 1.1 MPa yields a 32 μm thickness, as shown in (Table 1). Correspondingly, the electrical conductivity changes from about 680 S·cm⁻¹ (with a 0.1 MPa pressing force) to about 1136 S·cm⁻¹ (with a 1.1 MPa pressing force) an increases up to 67%, as shown in (FIG. 4C). This value is nearly three times higher than the published data for annealed graphene oxide paper, and stands out as one of the highest conductivity values reported so far reported for paper-like graphene structures (Table 2). In embodiments of the invention, it was observed that further compression of the graphene paper did not lead to smaller thickness, possibly due to internal resistances such as the van der Waals force.

FIGS. 6 to 8 illustrate electrical conductivity and mechanical properties of exemplary graphene paper produced in accordance with embodiments of the invention. FIG. 6 is graph demonstrating the density and areal density of graphene paper as a function of methane concentration during the chemical vapor deposition process. The error bars represent the standard deviations calculated based on 3 specimens for each sample. The thickness of all the samples used to calculate the density was ˜60 μm. FIG. 7 is a graph demonstrating the electrical conductivity of exemplary graphene paper prepared by different CH₄ concentrations. The error bars represent the standard deviations which were calculated based on 3 specimens for each sample. FIG. 8 is a graph demonstrating the electrical conductivity of exemplary 1.9 vol % CH₄ graphene paper as a function of the graphene paper thickness.

The proliferation of electronic devices in recent decades has greatly increased the potential for electromagnetic interference. Consequently, there is significant interest in the development of materials for electromagnetic interference shielding. Electromagnetic interference shielding effectiveness (EMI SE) is the reflection plus absorption of electromagnetic radiation by a material, which can be calculated in dB by taking logarithmic ratio of incoming power to transmitted power of an electromagnetic wave. Metals with good conductivity (e.g., copper, nickel, aluminum) show good performance for EMI SE. However, in many applications (such as aerospace electronics), the material for EMI shielding needs to have low density, thus making carbon materials competitive with metals. The specific EMI SE (EMI SE divided by density, often in dB·cm³/g) is frequently used for applications in which density is an important design factor. Research suggests that graphene has the potential to be an excellent EMI SE material, with up to 500 dB·cm³/g specific EMI SE. However, the poor mechanical properties of carbon materials developed with prior techniques (e.g., the graphene foam mentioned above) required a polymer coating, which enlarged the volume and adds additional processing steps. Achieving high EMI SE in the vicinity of 60 dB required a bulky volume for those materials, thus limiting their use as thin, protective layers for EMI of sensitive instruments.

In order to be comparable with previous work, similar EMI waveguides, which isolate the measurement environment from external radio frequency interferences, were used in the test. The EMI SE was calculated based on the equation as SE=−10 log₁₀|T|(dB), T=|S₂₁|², in which T refers to the transmittance of the shield and S₂₁ refers to the scattering parameter. Since the graphene paper prepared in accordance with embodiments of the invention was highly conductive and with low density, both high EMI SE and specific EMI SE were expected. Graphene paper with thickness of about 50 μm, fabricated with 0.9 vol % CH₄ concentration showed a SE of about 40 dB (FIG. 5B, tracing i) and this value increased up to about 60 dB when the methane concentration was raised to 1.1 vol. % (FIG. 5B, tracing ii) and 1.9 vol % (FIG. 5B, tracing iii). To achieve further improvements of the EMI SE, two approximately 50 μm thick graphene papers synthesized with 1.9 vol. % CH₄ concentration were overlapped during an additional EMI SE test. The obtained SE showed a value higher than 100 dB (FIG. 5B, tracing iv). The obtained values from a graphene material with such a small thickness of about 100 μm can be hardly achieved by any other carbon nanostructured material without metal coatings. This suggests that graphene paper made in accordance with the invention is a strong candidate for replacing metals in EMI shielding applications (Table 3). When prepared from 1.1 vol. % CH₄ concentration, the graphene paper revealed a specific EMI SE of 91.5 dB·cm³/g (FIG. 5C), which is almost one order higher than the one reported for copper and nickel. Graphene paper manufactured with 1.9 vol. % CH₄ also had good conductivity and EMI SE. However, due to its higher density compared to the 1.1 vol % CH₄ sample, it revealed specific SE of 68.38 dB·cm³/g, which was slightly lower than 1.1 vol % CH₄ sample. When CH₄ concentration was raised above approximately 2 vol %, the specific SE decreases, due to the resulting drop in conductivity and increase in density.

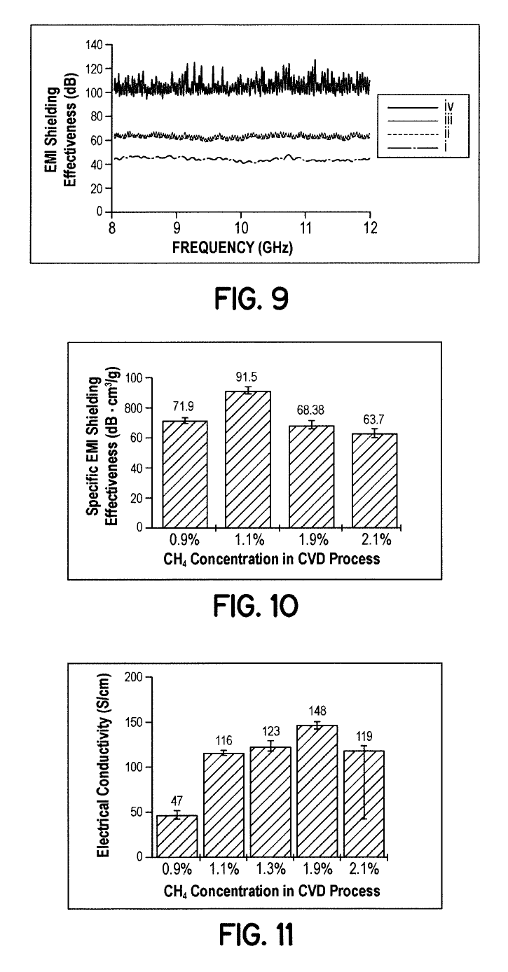

FIGS. 9 and 10 show the EMI shielding effectiveness of exemplary graphene paper prepared in accordance with embodiments of the invention. FIG. 9 is a tracing of EMI SE from exemplary graphene paper fabricated with (i) 0.9 vol % CH₄, (ii) 1.1 vol % CH₄, (iii) 1.9 vol % CH₄, and (iv) two overlapping specimens with 1.9 vol % CH₄. FIG. 10 is a graph depicting specific SE of graphene paper manufactured with different CH₄ concentrations in accordance with embodiments of the invention. The error bars represent the standard deviations which were calculated based on 3 specimens for each methane concentration. The SE was calculated by averaging the data from 8 GHz to 12 GHz.

As mentioned above, graphene pellet may be processed to form an electrode. In an embodiment, the graphene pellet 14 provides a scaffold electrode for pseudocapacitive materials and redox additive electrolyte systems. In an exemplary, the graphene pellet 16 is coated, such as with electrochemical coating, with a pseudocapacitive material, such as MnO₂, polypyrrole, or polyanailine, to provide electrodes.

In an embodiment of the method for making an electrode, the graphene pellet 14 is immersed in a plating solution containing the desired pseudocapacitive material, such as MnO₂. In an exemplary embodiment, the MnO₂ contains 20 mM MnSO₄ and 100 mM Na₂SO₄. The graphene pellet is subjected to deposition for a duration of time and a current sufficient to result in an amount of deposition of MnO2 for the coated graphene pellet to function as an electrode. In an embodiment, the duration is from 5 min to 40 min. In an embodiment, the current density is 2 mA cm⁻². After deposition, the resulting plated pseudocapacitive material graphene composite (e.g., a graphene/MnSO₂ composite) is washed in deionized water and dried. The plated pseudocapacitive material graphene composite may be used as an electrode.

In another embodiment of the method for making an electrode, the graphene pellet 14 immersed in a mixture solution of a polymerizing pseudocapacitive material, such a polypyrrole or polyaniline. In an embodiment, the polymerizing pseudocapacitive material is polypyrrole (1000 uL) ethanol/deionized water/1M hydrochloric acid (1:1:1, v/v/v) and amine p-toluene-sulfonate. An oxidant, such as ammonium persulfate, is added to the mixture and the chemical polymerization is carried out at a reduce temperature for a duration sufficient to result in the coated graphene pellet to function as an electrode. In an exemplary embodiment, the polymerization reaction is carried out at a temperature in a range from 0° C. to 5° C. and for a duration of 30 min. The resulting polymerized pseudocapacitive material graphene composite (e.g., graphene/polypyrrole composite) is then washed in deionized water and dried. The polymerized pseudocapacitive material graphene composite may be used as an electrode.

The plated pseudocapacitive material graphene composite (e.g., a graphene/MnSO₂ composite) and the polymerized pseudocapacitive material graphene composite (e.g., graphene/polypyrrole composite) may be used build an electrochemical cell. The plated pseudocapacitive material graphene composite may be used as a positive electrode and the polymerized pseudocapacitive material graphene composite may be used as a negative electrode. The electrodes may be assembled in a housing wherein the electrodes are separated from one another by an aqueous electrolyte (e.g., 1 M Na₂SO₄). The aqueous electrolyte may be soaked into a separator.

Aspects of the invention described above are directed to a polymer free process for the synthesis of 3D graphene structure, referenced herein primarily as a graphene pellet, and graphene paper, using an inexpensive nickel pellet as the template during chemical vapor deposition synthesis. The 3D graphene structure and graphene paper are mechanically robust. The graphene paper shows high electrical conductivity, attributed to the high quality of individual graphene flakes and their well-connected three-dimensional structure. The graphene paper prepared in accordance with embodiments of the invention also reveals excellent values of EMI SE and specific EMI SE. The synthesis and processing described here to manufacture the graphene paper is scalable. Larger nickel pellets will yield large 3D graphene structures and paper. The obtained graphene paper and the graphene pellet has a great potential for use in a wide range of application including, but not limited to EMI shielding, sensors, batteries, and supercapacitors. In particular, additional aspects of the invention are directed to coated 3D graphene structures, i.e., coated graphene pellets, functional as electrodes in electrical devices. The aspects of the inventions generally described and exemplified above are exemplified in greater detail in the examples that follow.

### Example 1

Nickel powder (Alfa Aesar) of 2-3 μm average particle size and 0.68 m²/g in specific surface area was pelletized into 6.4 cm diameter pellets using a compression machine (Carver, 973214A). The applied force was ˜10 MPa, and varied for different pellet thicknesses. The nickel pellet was placed in a quartz tube for growing of graphene by chemical vapor deposition. The nickel pellet was heated up to 1,000° C. in a tube furnace (FirstNano, ET1000) under Ar (1000 s.c.c.m.). Hydrogen (325 s.c.c.m.) was then introduced for 15 min to reduce any metal catalyst oxide. Then, CH₄ was introduced for 5 minutes. Various hydrocarbon flow rates were tested (12, 15, 18, 25 and 28 s.c.c.m, corresponding to concentrations of 0.9, 1.1, 1.3, 1.9 and 2.1 vol %, respectively). The pellet was then cooled to room temperature with a rate of ˜100° C./min under Ar (1000 s.c.c.m.) and H₂ (325 s.c.c.m.). The nickel pellet shrank ˜30% in all dimensions after chemical vapor deposition. The final 3D graphene structure in the form of a pellet was produced by etching out nickel from the graphene/nickel pellet with HCl (3M) at 80° C. for 10 h. The obtained graphene pellet was washed with water to remove residual acid and dried at room temperature.

Graphene paper was obtained by compressing the graphene pellet with the same press used to make the nickel pellet. Different thicknesses of graphene paper can be fabricated by changing the compression load (Table 1).

Microscopic characterization. SEM (FEI XL30, 15 kV), Raman spectroscopy (Renishaw in Via, excited by a 514 nm He—Ne laser with a laser spot size of ˜1 μm²) and TEM (FEI CM20, 300 kV) were used to characterize the of graphene paper. For the SEM tests, the sample did not need any additional conductive coating due to the high electrical conductivity of the graphene paper. For the TEM observations, graphene paper was ultrasonically dispersed in ethanol for 30 min and then a drop was applied to a TEM grid for testing.

Electrical and mechanical measurements. A four-point probe (Jandel RM3000) was used for electrical measurement of the samples. The electrical conductivity was calculated based on the thickness of graphene paper. The thickness of the paper was measured by a micrometer. The strength of the graphene paper was evaluated by employing a mechanical testing system (Instron 5948). The test sample were cut into 10 mm×1 mm coupons and tested at a strain rate of 0.5 mm/min

EMI shielding effectiveness measurement. The EMI shielding effectiveness was measured in the X-band frequency ranging from 8 GHz to 12 GHz using two waveguide-to-coaxial adapters and a vector network analyzer (Agilent N5222A). The scattering parameter (S₂₁) between the two waveguide-to-coaxial adapters was determined by the vector network analyzer. The samples were cut into 2.5 mm×1.3 mm coupons with thickness ˜50 μm and placed into the narrow waveguide gap created for the for measurement as shown in FIG. 5A.

Prior to graphene synthesis, the round nickel pellet was cut into a smaller rectangular shape, due to size limitations of the utilized chemical vapor deposition furnace. The nickel pellet was reduced to ⅔ of its original size, in all dimensions, after the chemical vapor deposition processing, possibly due to sintering. Further shrinking took place during the drying process of graphene pellet after the Ni template was etched out, most likely due to the liquid capillary forces caused by the water evaporation. The graphene paper did not break with bending, folding or hanging on a thin wire. It can be easily recover from the 180° folding.

TABLE 2
Comparison of the electrical conductivity of graphene
paper with other graphene-based materials.

| | Sheet resistance | Electrical conductivity |
|---|---|---|
| Materials | (Ω/sq) | (S · cm⁻¹) |
| Graphene oxide paper | NA | 118-351 |
| Graphite flakes | 3.01 | 291 |
| chemical vapor | 0.33 | 1097 |
| deposition graphene | | |
| Highly RGO | NA | 72-160 |
| Graphene foam | NA | 10 |
| 1.9 vol % CH₄ | 0.28 | 1136 |
| Graphene paper | | |

TABLE 3
Comparison of the electromagnetic interference
(EMI) shielding effectiveness (SE) of graphene
paper with other EMI shielding materials.

| | | EMI | Specific | |
|---|---|---|---|---|
| | Filler | SE | EMI SE | Thickness |
| Materials | content | (dB) | (dB · cm³/g) | (μm) |
| Copper | NA | 90 | 10 | 3.1 |
| Nickel | NA | 82 | 9.2 | NA |
| Graphene/PDMS foam | ~0.8 wt % | 30 | 500 | 1000 |
| MWCNT/ | 12 wt % | 42-48 | NA | 3800 |
| fluorocarbon foam | | | | |
| Graphene/foam | 7 wt % | 28 | NA | NA |
| CNT/PS foam | 7 wt % | 19 | 33 | 1200 |
| Graphene paper | NA | 62 | 91.5 | ~50 |

### Example 2

Aspects of the invention are directed to making a seamless 3D graphene structure called graphene pellet synthesized through chemical vapor deposition by using inexpensive nickel powder as catalyst template. The graphene pellet is an important new platform for fabricating of high performance pseudocapacitor electrode.

Nickel powder (Alfa Aesar) of 2-3 mm average particle size and 0.68 m2 g⁻¹ in SSA was pelletized into a 6.4 cm diameter pellet using a hydraulic press (Carver, 973214A). The sample described above was heated up to 1000° C. in a tube furnace (FirstNano, ET1000) under Ar (1000 sccm). Hydrogen (325 sccm) was then introduced for 5 min, to reduce any metal catalyst oxide. Then, 25 sccm of CH4 was introduced for 1 minute. The sample was then cooled to room temperature at a rate of 100° C. min′ under Ar (1000 sccm) and H2 (325 sccm). The final 3D graphene structure in the form of a pellet was produced by etching out nickel from the graphene/nickel pellet with 3 M HCl at 80° C. for 10 h. The obtained graphene pellet was washed with DI water to remove the residual acid.

MnO2 was coated on the graphene pellet by electrodeposition in the following way. graphene pellet was immersed into a plating solution containing 20 mM MnSO₄ and 100 mM Na₂SO₄, and subjected to 5 min to 40 min deposition under a constant current density of 2 mA cm⁻². After electrodeposition, the graphene pellet was washed with DI water to remove the residual electrolyte, and then dried at 60° C. for 2 h. The mass of the sample was measured before and after electrode-position of MnO₂, using a microbalance (Sartorius Micro Balance MSE6.6S-000-DF). This enabled the mass ratio of MnO2 in the GP/MnO2 composite to be calculated.

The graphene pellet/polypyrrole (Ppy) hybrid electrode was synthesized using an in situ polymerization method. Generally, a graphene pellet was immersed into a mixture solution of pyrrole (1000 mL, from Sigma-Aldrich), ethanol/DI water/1 M HCl (1:1:1, v/v/v) and amine p-toluene-sulfonate (pTSNH4, dopant, from Byk). Ammonium persulfate (APS, (NH₄)₂S₂O₈, oxidant, from Fisher Scientific) was then added to the mixture solution and the chemical polymerization was carried out at 0-5° C. for 30 min. The as-made graphene pellet/Ppy sample was then washed with DI water and dried at 50° C.

The asymmetric electrochemical cells were fabricated by making the graphene pellet/MnO₂ composite as the positive electrode and the graphene pellet/Ppy composite as the negative electrode, and finally assembling both electrodes into a coin cell device. The two electrodes were separated by an aqueous electrolyte (1 M Na₂SO₄) soaked separator (nitrocellulose film).

Scanning electron microscopy (SEM) (FEI XL30, 15 kV), Raman spectroscopy (Renishaw in Via, excited by a 514 nm He—Ne laser with a laser spot size of ˜1 μm²) and the surface characterization analyzer (Micromeritics, 3Flex) were used to characterize the graphene pellet. XPS data were obtained using a VG Multilab 2000 (Thermo VG Scientific) with a monochromatic Mg KR X-ray source (hv=1253.6 eV) in a chamber maintained at 10⁻⁷ Torr. The high-resolution scans of C and low-resolution survey scans were analyzed for each sample at two or more separated locations.

Brunauer-Emmett-Teller (BET) study of graphene pellets to determine pore size. Nitrogen adsorption-desorption isotherms and Barrett-Joyner-Halenda (BJH) pore size distribution were studied by using a surface characterization analyzer (Micromeritics, 3Flex).

A four-point probe device (Jandel RM3000) was used for electrical measurement of the samples. Four terminals of the probe were slightly compressed on the surface of a graphene pellet sample with dimensions of 1 cm×1 cm. The electrical conductivity was calculated based on the thickness of graphene pellet, which was measured from cross-sectional SEM images. The thickness measurement of graphene pellet displays a typical error with the range of about ±3% A minimum of three samples were measured to calculate each error bar.

For conducting the resistance retention test, a four-point probe bending device was used. In these measurements, copper wires were embedded and connected to graphene pellet with silver paste, which enabled a reliable electrical contact between the copper wires and the graphene pellet which enabled a small contact resistance. A minimum of three samples were measured to calculate each error bar.

The electrochemical measurements were carried out in a Gamry instrument (PWR 800) at room temperature using three-electrode configuration for the graphene pellet and graphene pellet/MnO₂ electrodes and two-electrode configuration for asymmetric ECs. In the three-electrode configuration, the freestanding graphene pellet and graphene pellet/MnO₂ samples served as the working electrode without the use of any metal support. They were combined with a Ag/AgCl reference electrode and a Pt counter electrode in an electrolyte solution of 1 M Na₂SO₄. Additives such as 50 mM hydroquinone (HQ) and 50 mM benzoquinone (BQ) were prepared along with 1 M H₂SO₄ and 30% acetic acid (stabilizer for HQ and BQ) used as the electrolyte. The electrochemical characteristics of 0.2 mg graphene pellets, 1 mg graphene pellet/MnO₂ composites (total mass of the electrode with both graphene pellets and MnO₂) and 5 mg asymmetric ECs (total mass of two electrodes with both graphene pellets and active materials including Ppy and MnO₂) were evaluated by cyclic voltammetry, galvanostatic charge-discharge and electrochemical impedance spectroscopy measurements over a frequency range from 10⁵ to 10⁻² Hz at a sinusoidal voltage amplitude of 10 mV.

The specific capacitance in the three-electrode system was calculated by using the equation C=It/(DVm), and the volumetric capacitance was calculated by a similar expression Cᵥ=rC, where I is the discharge current, t is the discharge time, DV is the operating voltage window, m is the individual electrode mass (including graphene pellets and active materials), and r is the density of the electrode.

To achieve good capacitance performance of the asymmetric electrochemical supercapacitors (ECs), the mass of the two electrodes was balanced based on the following equation: C⁻DV⁻m⁻=C⁺DV⁺m⁺, where C is the specific capacitance of a single electrode, DV is the operating voltage window, and m is the mass of the electrode.

The energy density (E), power density (P) and maximal power density (Pₘ) were calculated by the expressions: E=C_{cell}(DV)²/₂, P=Er⁻¹, and Pₘ=DV²/₄Rm, where C^{cell} is the cell capacitance calculated by C_{cell}=It/(DVm), DV is the operating voltage window, t is the discharge time, I is the discharge current, m is the total mass of the two electrodes, and R is the internal resistance calculated from the IR drop of the charge-discharge curve.

Results

The seamless chemical vapor deposition-made 3D graphene structure was prepared as described above in Example 1. The highly porous structure of GF contributes to a high surface area, but at the same time lowers its electrical conductivity due to the prolonged electron pathway. As will be discussed below, the electrical conductivity of graphene foam is by 2 orders lower than that of graphene pellets in this work. Moreover, the Ni catalyst used herein yields 3.0 mg graphene per gram of nickel powder compared to the Ni foam yielding only 0.4 mg per gram of nickel.

The study of SSA, pore size distribution and electrical conductivity is important to realize the performance of a carbon scaffold for pseudocapacitor application. Though the obtained graphene pellet has a moderate SSA (˜80 m² g⁻¹), it shows a mesopore (˜2 nm) dominated structure, which is beneficial in facilitating a quick diffusion of electrolyte ions as suggested by other groups. Furthermore, the electrical properties of graphene pellets outperform those of other reported graphene scaffold materials for pseudocapacitor electrode applications as shown in Table 4 below. The high electrical conductivity (148 S cm⁻¹) of graphene pellets is attributed to the good quality of graphene prepared by chemical vapor deposition and improved flake to flake contact compared to graphene samples obtained by wet chemistry methods. In addition, due to the compression and the sintering process, the well interconnected nickel grains help to form a seamless 3D graphene structure, which results in a higher electrical conductivity of the samples compared to other chemical vapor deposition-made 3D graphene materials. The electrical conductivity of the 3D graphene described herein can be controlled by the methane concentration during the chemical vapor deposition process as demonstrated in FIG. 11. It can be seen here that the electrical conductivity of graphene pellets starts at a relatively low value of 47 S cm⁻¹ and rises up to 148 S cm⁻¹ with the increase of methane concentration during chemical vapor deposition. This phenomenon could be attributed to the higher methane concentration causing more graphene to grow on the sintered nickel skeleton, which results in a better-interconnected graphene structure. It is worth mentioning that beyond a threshold value of methane concentration, the electrical conductivity decreases. This threshold value in embodiments described herein is 1.9 vol % as observed in FIG. 11. This is probably due to the inability of the catalyst to absorb methane when the methane concentration exceeds a certain saturation point.

TABLE 4
Electrical Conductivity comparison of different
graphene scaffolds for EC electrodes.

| | Electrical Conductivity |
|---|---|
| Materials | (S cm⁻¹) |
| Embossed chemically modified graphene | 12.04 |
| Reduced graphene oxide | 5.65 |
| Graphene foam | 1 |
| CNT/graphene foam hybrid film | 1.9 |
| Graphene pellet | 148 |

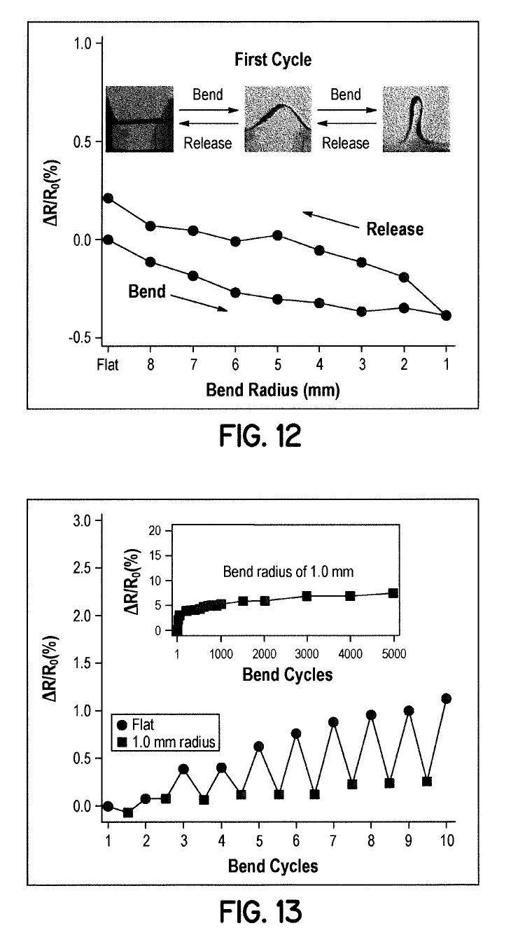

The fast development of wearable devices and related power sources nowadays demands for electrode materials with good mechanical and electrical properties. The graphene pellets described herein have beneficial characteristics such as high electrical conductivity, good mechanical robustness, and flexibility. Therefore, they are expected to perform well when incorporated as flexible electrodes in devices integrated with woven and non-woven fabric. The effect of bending on the electrical resistance of graphene pellets prepared using 1.9 vol % CH4 with 1 min saturation time during chemical vapor deposition, which reveals the best electrical conductivity among all the prepared samples was studied. The bend and stretch tests were carried out using a 4-point bending device and a high-precision mechanical system. The electrical resistance revealed a small decrease when bending up to a radius of 1.0 mm and could recover after straightening with a resistance increase of only 0.21% (FIG. 12). It is interesting to point out that the resistance of graphene pellets decreased during the bending process, which could be attributed to the compacting effect of 3D graphene pellets during bending. FIG. 13 shows the cyclic bend and release test of graphene pellets at a very small bend radius of 1.0 mm. The resistance of graphene pellets increases rapidly in the first 10 cycles and becomes stable after 1000 cycles (FIG. 13 inset). There is only 7.3% increase in resistance after 5000 cycles at the tested small bend radius of 1.0 mm. These results illustrate the excellent electromechanical stability of graphene pellets compared with conventional materials used in flexible electronics and other graphene materials such as graphene foam and graphene films.

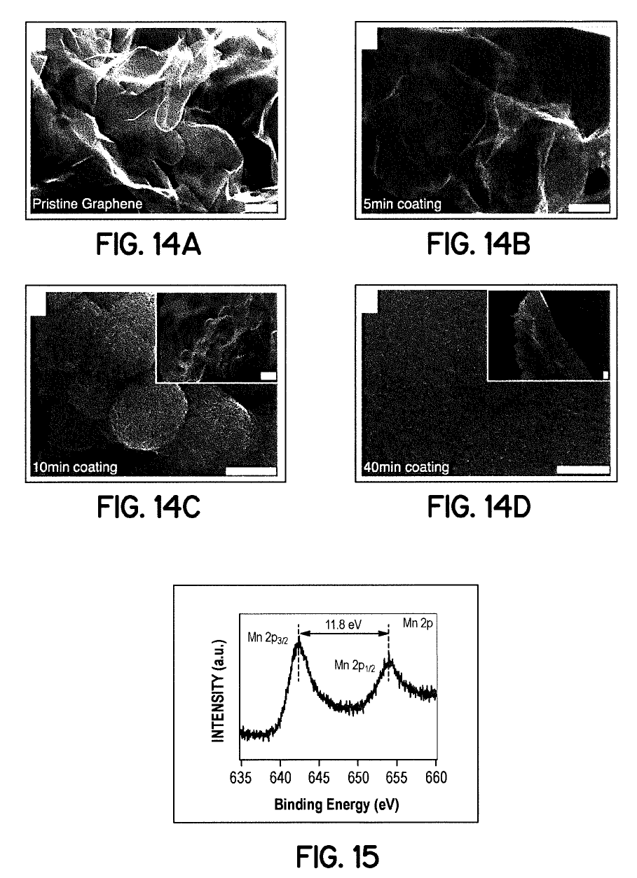

The good electrical and mechanical properties of the 3D graphene pellet make it an excellent candidate for energy storage applications. To explore this opportunity, a typical pseudocapacitive material—MnO₂, was studied to investigate the synergistic effect between graphene pellets and this metal oxide. A layer of MnO₂ was electrochemically deposited on the surface of graphene pellets by oxidation of Mn²⁺ to Mn⁴⁺ in solution, following a procedure described in the literature. FIGS. 14A-14D show SEM images revealing the morphology of graphene pellets after electrochemical coating with MnO₂ with different mass loadings. The latter was controlled by manipulating the time of electrodeposition, which was varied from 5 min to 40 min. Compared to pristine graphene pellets (FIG. 14A), the deposited graphene pellet/MnO₂ (11.4 wt % MnO₂) in FIG. 14B showed cluster formation of the coating. These clusters transformed into sphere-like structures when the MnO₂ content was increased to 54.5 wt % as shown in FIG. 14C. The inset in the SEM image in FIG. 14C displays the cross-section of graphene pellet/MnO₂ (54.5 wt % MnO₂), where the embedment of MnO₂ spheres into the surface of graphene pellets is revealed. This embedment suggests a good contact between MnO₂ and graphene pellets, which can be attributed to the unique porous surface morphology of graphene pellets. In FIG. 14D showing the morphology of the graphene pellet/MnO₂ (79.6 wt % MnO₂) sample, the spheres of the metal oxide merge into a bulk layer. The inset in the SEM image displays the cross-section view of the coating. Though the thickness of the MnO₂ layer is relatively large compared to those of other reported studies, the good electrical properties of graphene pellets and the intimately integrated MnO₂ and graphene pellets compensate the low electrical conductivity of MnO₂. The calculated areal densities of graphene pellet/MnO₂ composites with 0 wt %, 11.4 wt %, 54.5 wt % and 79.6 wt % MnO₂ are 4.5 g m⁻², 5.1 g m², 9.9 g m⁻² and 22.3 g m⁻², respectively. These data illustrate the ability of graphene pellets to accommodate a high content of MnO₂. The formed MnO₂ thin layer on graphene pellets was further investigated by X-ray photoelectron spectroscopy (XPS). As shown in FIG. 15, two characteristic peaks of Mn 2p_{1/2} and Mn 2p_{3/2} at 654.1 and 642.4 eV, respectively, with a binding energy separation of 11.7 eV were observed.

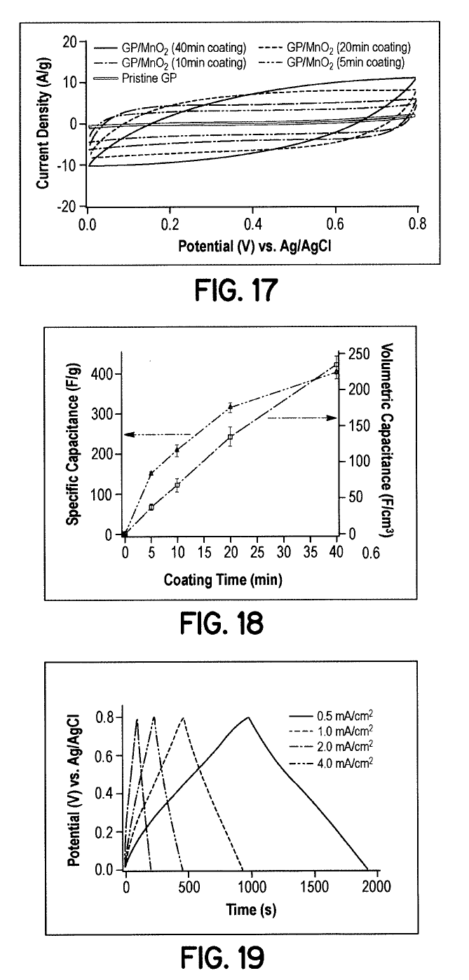

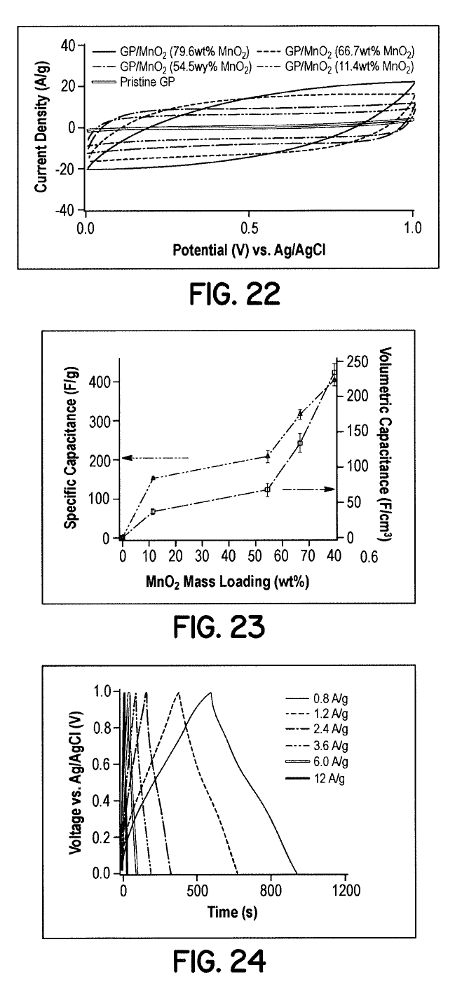

The electrochemical performances of graphene pellets and graphene pellet/MnO₂ composites as capacitive electrodes were evaluated using a conventional three-electrode system in an aqueous electrolyte solution of 1 M Na₂SO₄. As shown in FIGS. 17 and 22, the cyclic voltammetry (CV) curves of graphene-MnO₂ composites reveal no redox peaks due to the surface adsorption/desorption of protons (H⁺) or alkaline cations (M⁺) on the MnO₂ surface, indicating that the composites have an ideal capacitive behavior. The main capacitance contributor in the graphene pellet/MnO₂ composite is expected to be the pseudocapacitance provided by MnO₂, instead of the double-layer capacitance from graphene pellets. The latter can be proved by the fact that during the CV test increasing the MnO₂ mass loading from 11.4 wt % to 79.6 wt % results in a much higher current density compared to pristine graphene pellets. The electrochemical performance of higher MnO₂ mass loading than 79.6 wt % on the graphene pellets was not studied. The rationale for this came from the obtained CV data suggesting a deviation from the most favorable rectangular shape at 79.6 wt % MnO₂ compared to a lower MnO₂ content on the graphene pellets. This can be interpreted based on the well-known high resistive behavior of MnO₂. The capacitive performance of graphene pellet/MnO₂ composite electrodes was further investigated by the charge-discharge test. For practical applications, both specific capacitance and volumetric capacitance are critical considering the limited space and load under certain circumstances. FIGS. 18 and 23 show the increase of both specific and volumetric capacitance of graphene pellet/MnO₂ composite electrodes due to the increased mass of MnO₂ as revealed by the SEM images in FIGS. 14A-14D. The graphene pellet/MnO₂ composite electrode shows specific and volumetric capacitance up to 395 F g⁻¹ and 230 F cm⁻³, which outperforms many other carbon/MnO₂ composite electrodes with specific and volumetric capacitance in the order of ˜150 F g⁻¹ and 100 F cm⁻³, respectively. This high value of volumetric capacitance is probably attributed to the more compact structure of graphene pellets compared to other reported porous carbon materials such as graphene foam. FIGS. 19 and 24 display the charge-discharge curves of graphene pellet/MnO₂ with 79.6 wt % MnO₂ mass loading. From the discharging curve, the specific capacitance of graphene pellet/MnO₂ with 79.6 wt % MnO₂ mass loading was calculated to be 395 F g⁻¹ at 0.8 A g⁻¹. These values are higher than those of other reported graphene/MnO₂ materials including the GF/MnO₂ composite (240 F g⁻¹, 0.1 A g⁻¹), MnO₂/graphene composite paper (256 F g⁻¹ at 0.5 A g⁻¹), conductive wrapping MnO₂/graphene composite (380 F g⁻¹ at 0.1 mA cm⁻²), and 3D graphene/MnO₂ composite (389 F g⁻¹ at 1 A g⁻¹).

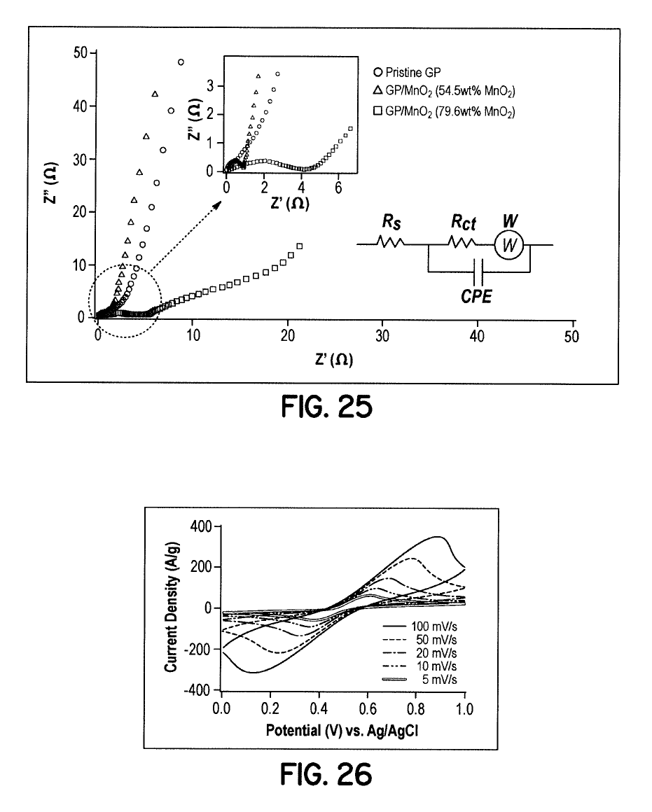

The synergy of graphene pellets as a conducting scaffold for MnO₂ in applications as a pseudocapacitive material was further studied by alternating current impedance measurements at a frequency range from 100 kHz to 0.01 Hz. The obtained results are displayed in FIGS. 21 and 25 in the form of Nyquist plots. The pristine graphene pellet shows a negligible charge transfer resistance (R_{ct}), which represents the resistance at the interface of the electrode and electrolyte. This result proves the excellent conductivity of graphene pellets at the electrode-electrolyte interface. Based on the equivalent series circuit (FIG. 25 inset), the R_{ct} of the graphene pellet/MnO₂ composite electrodes with 54.5 wt % and 79.6 wt % MnO₂ mass loading was calculated. The obtained values were 1.1 and 3.78, respectively. There is a clear trend showing that the increase of MnO₂ mass loading from 54.5 wt % to 79.6 wt % results in the increase of R_{ct}, due to the poor electrical conductivity of MnO₂. Still, the R_{ct} values of graphene pellet/MnO₂ composite electrodes are relatively small compared to other reported graphene/MnO₂ composite electrodes, which supports our assumption that graphene pellets can work effectively as a good conducting scaffold in combination with low electrically conductive pseudocapacitive materials such as MnO₂. In the low frequency region, the slope of the curve represents the electrolyte and proton diffusion resistance. The pristine graphene pellet shows the most ideal straight line along the imaginary axis. A typical Warburg capacitive behavior was observed in which the curve slope decreases with increasing the mass loading of MnO₂, thus indicating higher resistance for ion/proton diffusion.

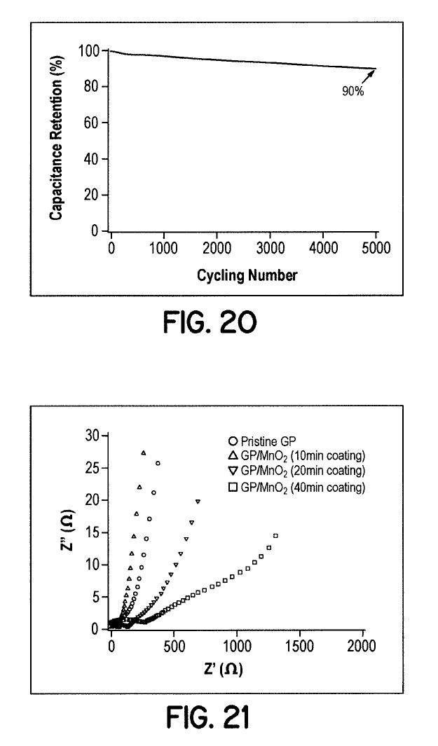

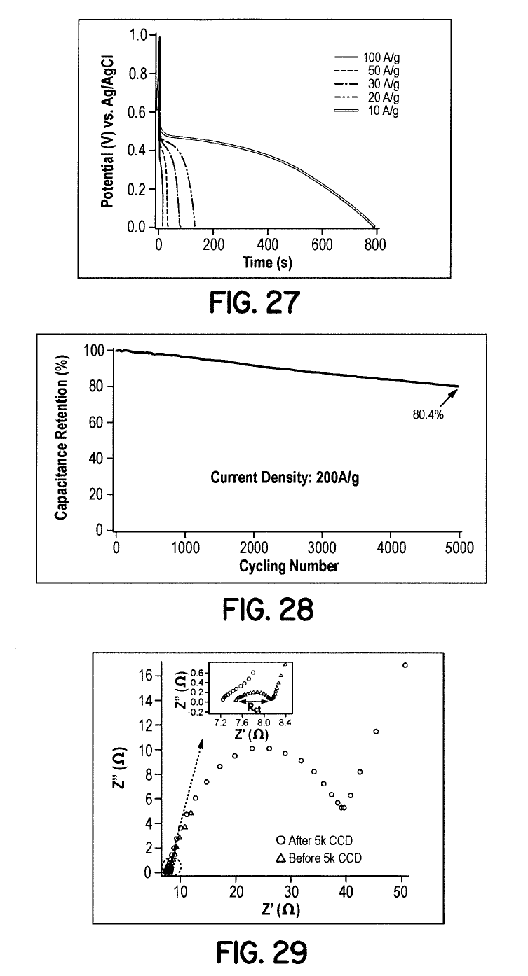

The electrochemical performance of graphene pellets in a redox additive electrolyte system that has been studied intensively in recent years due to its ease of preparation and the potential to yield high energy density was also investigated herein. Based on the results herein, it is believed that the excellent electrical properties of graphene pellets can greatly facilitate the chemical reaction of redox additives. FIG. 26 shows the CV curves of the pristine graphene pellet in 1 M H₂SO₄ and 30% acetic acid electrolyte with 50 mM hydroquinone (HQ) and 50 mM benzo-quinone (BQ) as redox additives. A high current density in the potential range of 0-1.0 V and a couple of redox peaks (HQ to BQ and BQ to HQ) were observed. The charge-discharge curves in FIG. 27 exhibit an ultrahigh specific capacitance (7813 F g⁻¹) of graphene pellets at a high current density (10 A g⁻¹) in the HQBQ electrolyte system, which suggests a good synergy of graphene pellets with the redox additive electrolyte system. This ultrahigh specific capacitance comes from the redox reaction between HQ and BQ, and graphene pellets is proved to efficiently facilitate this process by working as a lightweight and conductive scaffold rather than a capacitive material. Interestingly, when the discharge current density was reduced from 20 A g⁻¹ to 10 A g⁻¹, a dramatic increase of specific capacitance was observed. Further decrease of the discharge rate down to 5 A g⁻¹ will lead to an undesirably long discharging time. This might be attributed to the sufficient diffusion of the redox couples into the graphene pellets at a relatively low current density and needs further studies. After 5000 cycles of charge-discharge at a very high current density of 200 A g⁻¹, the specific capacitance dropped by 19.6% (FIGS. 20 and 28) with an increase of R_{ct} after cyclic charge-discharge (CCD) (FIG. 29). One plausible reason for the increased R_{ct} is the agglomeration of BQ in the porous graphene structure considering the low solubility of BQ in water.

The full cell performance of asymmetric ECs made of graphene pellet/pseudocapacitive materials was also studied. Since the graphene pellet/MnO₂ electrode shows good capacitive performance in the potential range from 0 to 1.0 V, polypyrrole (Ppy) coated graphene pellets was employed as a negative electrode to expand the potential range of the asymmetric ECs. This is because Ppy has been proven to exhibit good capacitive performance in the working potential range from −0.6 to 0.2 V. It is also important to balance the charge of the positive and negative electrodes in order to maximize the energy density of ECs. In the present work, the electrochemical performance of the graphene pellet/Ppy electrode was also investigated. A successful coverage of graphene pellets by Ppy was proved by SEM images and Raman spectra. Further, the graphene pellet/Ppy electrode shows a specific capacitance of 247 F g⁻¹ at 1 A g⁻¹. The obtained results allowed balancing the mass ratio of the positive electrode (GP/MnO₂) and the negative electrode (GP/Ppy) to 1:2 in order to achieve the maximal energy density of ECs. The assembled EC in this work is represented as graphene pellet/MnO₂/Ppy EC. In this system MnO₂ stores energy by adsorption/desorption of protons (H⁺) or alkaline cations (Nat in our case) on the oxide surface, while Ppy stores energy by doping/de-doping of anions (SO₄²— in our case). In both cases graphene works as a conductive support for those two materials.

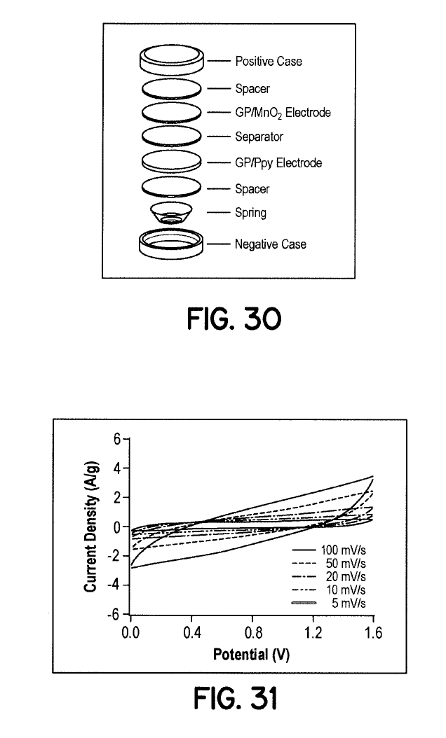

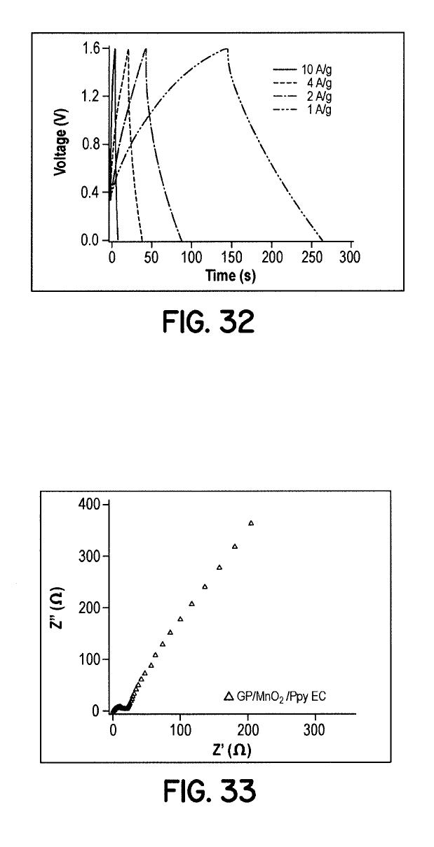

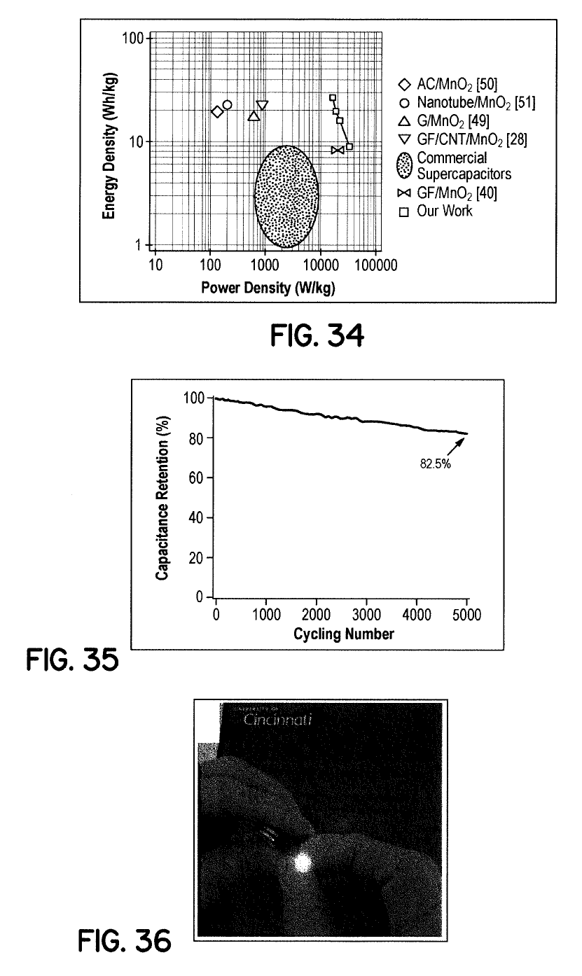

FIG. 30 illustrates a schematic structure of the assembled ECs composed of an electrolyte (1 M Na₂SO₄)-soaked separator sandwiched between positive and negative electrodes. The asymmetric EC shows a typical capacitive behavior in the potential range from 0 to 1.6 V as displayed in FIG. 31. Slow scan rates cause more pronounced rectangular shapes than high scan rates. This suggests a more resistive behavior of the device at higher scan rates. No redox peaks are observed in FIG. 31. The charge-discharge curves of graphene pellet/MnO2/Ppy EC under different current densities are displayed in FIG. 32. Based on the IR drop of the charge-discharge curves, graphene pellet/MnO2/Ppy EC exhibits small internal resistances of 24.5Ω, 36.3Ω, 44.0Ω and 48.7Ω at current densities of 10 A g⁻¹, 4 A g⁻¹, 2 A g⁻¹ and 1 A g⁻¹, respectively. The value of the obtained internal resistance is not as low as we expected considering the good electrical conductivity of graphene pellets. A possible explanation is that after the assembly of two different electrodes into a device, the resistance increases because of the differences in the storage mechanisms of these two electrodes. In particular, MnO₂ stores energy based on the adsorption/desorption of protons (H⁺) or via alkaline cations (Mt) on the oxide surface, while Ppy stores energy by doping and de-doping of anions. The different mechanisms result in different charge-discharge speeds that contribute to the increased internal resistance of the device. The Nyquist plot in FIG. 33 reveals 0.8Ω electrolyte resistance (Rₛ) and 24.8Ω charge transfer resistance R_{ct}, suggesting a fast charge transfer between the electrolyte and electrodes. The energy density and power density of graphene pellet/MnO₂/Ppy EC was further calculated based on the charge-discharge curves in FIG. 32. The obtained results are presented as a Ragone plot in FIG. 34. The graphene pellet/MnO₂/Ppy EC in the present work shows a maximum energy density of 26.7 W h kg⁻¹ at a power density of 798 W kg⁻¹, and a maximum power density (Pₘ) of 16.4 kW kg⁻¹. The highest Pₘ was found to be 32.7 kW kg⁻¹ with an energy density of 8.9 W h kg⁻¹ at a power density of 8.0 kW kg⁻¹. Such performance is superior compared to other ECs reported in the literature, especially with regard to a similar GF/MnO₂ device showing a lower energy density of 8.3 W h kg⁻¹ at a power density of 20 kW kg⁻¹ respectively. The graphene pellet/MnO₂/Ppy EC also exhibits a good cycle life with 85% capacitance retention after 5000 cycles of charge-discharge at 10 A g⁻¹ (FIG. 35). Furthermore, two stacked graphene pellet/MnO2/Ppy ECs were able to power a LED (3.0 V, 30 mA) for 1.5 min as shown in FIG. 36.

### CONCLUSIONS

Reported herein is a new design and fabrication process of an electrode material called graphene pellets (GPs) for energy storage applications. The employed catalyst in the form of a sintered nickel template can be easily converted into a graphene pellet by chemical vapor deposition. The graphene pellets exhibit good electrical conductivity, electromechanical stability and morphology with a mesoporous structure thus providing great potential for energy storage applications. Graphene pellet/MnO₂ composites prepared by the described simple electrochemical deposition of MnO₂ onto the graphene pellet surface showed both high specific and volumetric capacitance with small charge-transfer resistance. This demonstrates good synergy between graphene pellets and MnO₂. The excellent electrical and mechanical properties of graphene pellets also show great potential in facilitating chemical reactions typical for redox additive electrolyte systems. Moreover, when the graphene pellet/MnO₂ electrode was assembled with the graphene pellet/polypyrrole electrode, the obtained full coin cell showed good performance. The simplicity of the 3D graphene preparation allows graphene pellets to compete with or replace graphene foam in many energy storage applications.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A process for making graphene pellet (GP) with a three-dimensional structure comprising: forming a nickel pellet from nickel powder to function as a catalyst for graphene growth, exposing the nickel pellet to a hydrocarbon under conditions sufficient to grow graphene, and etching nickel from graphene with an acid resulting in a graphene pellet.

2. The process according to claim 1 further comprising pressing a nickel powder in a mold to form the pelletized nickel powder.

3. The process according to claim 1 further comprising sintering the nickel pellet prior to exposing the nickel pellet to a hydrocarbon.

4. The process of claim 1 wherein the nickel pellet is exposed to the hydrocarbon at a flow rate that corresponds to concentrations ranging from about 0.9 vol % to 2.1 vol %.

5. The process according to claim 1 wherein the graphene grown on the nickel pellet at a temperature of 1000° C. to about 1400° C. with CH₄ as the hydrocarbon and then cooling the graphene coated nickel pellet to room temperature with a rate of above about 50° C./min.

6. The process according to claim 5 further comprising exposing the nickel pellet to H₂ at a flow rate of 325 s.c.c.m. and Ar at a flow rate of 1000 s.c.c.m., and CH₄ at a flow rates ranging between about 10 s.c.c.m. and about 30 s.c.c.m. while maintaining a temperature in a range between 1000° C. to about 1400° C.

7. The process according to claim 5 wherein the CH₄ flow rate is selected from the group consisting of about 12 s.c.c.m., about 15 s.c.c.m., about 18 s.c.c.m., about 25 s.c.c.m. and about 28 s.c.c.m.

8. The process according to claim 5 wherein the CH₄ flow rate corresponds to a concentration selected from the group consisting of about 0.9 vol %, about 1.1 vol %, about 1.3 vol %, about 1.9 vol % and about 2.1 vol %.

9. The process according to claim 1 further comprising drying the graphene pellet in air after etching and obtaining a three-dimensional structure with reduced dimensions compared to the initial nickel pellet.

10. The process according to claim 1 wherein the graphene pellet is the form of a scaffold and further comprising forming a layer of MnO₂ on the graphene scaffold to obtain a graphene pellet/MnO₂ composite.

11. The process according to claim 10 wherein a layer of MnO2 is formed on the graphene pellet by electrochemical deposition of MnO₂ on the graphene scaffold to form a graphene pellet/MnO₂ composite.

12. The process according to claim 12 wherein the duration of electrochemical deposition ranges from about 5 minutes to about 40 minutes.

13. The process of claim 10 further comprising forming an electrode from the graphene pellet/MnO₂ composite.

14. The process of claim 13 further comprising forming an energy storage device from the graphene pellet/MnO₂ composite electrode.

15. The process of claim 1 further comprising wherein the graphene pellet is the form of a scaffold and further comprising forming a layer of polypyrrole on the graphene scaffold to obtain a graphene pellet/polypyrrole composite.

16. The process of claim 15 further comprising forming an electrode from the graphene pellet/polypyrrole composite.

17. The process of claim 15 further comprising forming an energy storage device from the graphene pellet/polypyrrole composite electrode.

18. The process of claim 1 further comprising applying a compression force to the graphene pellet to form a graphene paper.

19. The process of claim 18 wherein the compression force is applied in a range between 0.1 MPa and 1.1 MPa.

20. A graphene pellet formed according to the method of claim 1.

21. A graphene paper formed according to the method of claim 18.
